(19) United States
(12) Patent Application Publication
(10) Pub. No.: US 2026/0303419 A1
(43) Pub. Date: Oct. 1, 2026

(54) EXTENDED SYMBOL DECODING

(71) Applicant: Microchip Technology Inc., Chandler, AZ (US)

(72) Inventors: Peter Graumann, Calgary (CA); Fan Yang, Burnaby (CA)

(73) Assignee: Microchip Technology Inc., Chandler, AZ (US)

(21) Appl. No.: 19/298,263

(22) Filed: Aug. 13, 2025

Related U.S. Application Data
(60) Provisional application No. 63/779,029, filed on Mar. 27, 2025.

(51) Int. Cl. H04L 25/497; H04L 27/04; H04L 27/06

(52) U.S. Cl. CPC H04L 25/4975; H04L 27/04; H04L 27/066

(57) ABSTRACT

A system and method for an improved method of decoding a pulse amplitude modulation (PAM) symbol group employing a convolutional coding trellis are disclosed. The method may include receiving a first symbol group from a transmitter at a first time and identifying a first path and a second path corresponding to a state of the transmitter at the first time and containing at least two symbols. The method may include storing a final symbol of the first path and a final symbol of the second path. The method may include receiving a second symbol group at a second time and identifying, based on the final symbol of the first path, a third path corresponding to a state of the transmitter at the second time and identifying, based on the final symbol of the second path, a fourth path corresponding to the state of the transmitter at the second time.

### PRIORITY

This application claims priority to U.S. Provisional Patent Application No. 63/779,029 filed Mar. 27, 2025, the contents of which are hereby incorporated in their entirety.

### TECHNICAL FIELD

The present disclosure relates to high-speed communications, and in particular, to an improved method of decoding a pulse amplitude modulation symbol group employing a convolutional coding trellis.

### BACKGROUND

PAM5 (Quinary Pulse-Amplitude Modulation) is a modulation technique used in Serializer/Deserializer (SerDes) systems, specifically for high-speed data transmission. It utilizes five distinct signal levels to encode data, with each level representing a symbol. PAM5 may allow for a higher data rate compared to lower-order PAM schemes like PAM4, as each symbol can carry more information. PAM5 encodes data by varying the amplitude of a signal across five voltage levels. Specifically, each symbol is represented by one of five voltage levels (e.g., −2, −1, 0, +1, +2). This means that each symbol can represent two bits of data, effectively doubling the symbol rate compared to binary encoding. PAM5 allows for the transmission of more bits per symbol compared to other modulation schemes.

PAM5 may be combined with a form of convolutional coding to ensure reliable high-speed data transmission. Prior to PAM5 modulation, the digital data undergoes trellis encoding, a type of convolutional coding that adds redundancy to the signal. This redundancy is incorporated into the data stream, allowing the receiver to detect and correct errors introduced during transmission. The resulting encoded data is then modulated using PAM5, where five distinct voltage levels represent the encoded symbols. At the receiving end, the Viterbi algorithm effectively decodes the received PAM5 signal by leveraging the added redundancy from the trellis encoding, reducing the impact of noise and interference and ensuring accurate data recovery.

### SUMMARY OF THE INVENTION

Aspects provide systems and methods for an improved method of decoding a pulse amplitude modulation symbol group employing a convolutional coding trellis. Examples of the present disclosure may include a method. The method may include receiving a first PAM symbol group from a transmitter at a first time. The method may also include identifying a first path and a second path. The first path and the second path may correspond to a state of the transmitter at the first time and each may contain at least two symbols. The method may additionally include storing a final symbol of the first path and a final symbol of the second path. The method may include receiving a second PAM symbol group from the transmitter at a second time. The method may also include identifying, based on the final symbol of the first path, a third path corresponding to a state of the transmitter at the second time. The method may further include identifying, based on the final symbol of the second path, a fourth path corresponding to the state of the transmitter at the second time.

In combination with any of the above examples, identifying the third path and identifying the fourth path may include calculating a plurality of scores for a plurality of potential paths corresponding to the state of the transmitter at the second time. Identifying the third path and identifying the fourth may also include selecting the third path and the fourth path from the plurality of potential paths. The third path and the fourth path may have lower scores than other of the plurality of potential paths.

In combination with any of the above examples, a final symbol of the third path may be different from a final symbol of the fourth path.

In combination with any of the above examples, a score for the first path may include an effect of the final symbol of the first path on a first symbol of the third path and a score for the second path may include an effect of the final symbol of the second path on a first symbol of the fourth path.

In combination with any of the above examples, the first PAM symbol group may include a first plurality of pre-bits, a first plurality of decode bits, and a first plurality of post-bits. The second PAM symbol group may include a second plurality of pre-bits, a second plurality of decode bits, and a second plurality of post-bits.

In combination with any of the above examples, identifying the first path and identifying the second path may include processing the first plurality of pre-bits of the using an 8:2 multiplexer and processing the first plurality of decode bits to identify the first path and identify the second path using a first 4:1 multiplexer. identifying the third path and identifying the fourth path may include processing the second plurality of pre-bits using the 8:2 multiplexer and processing the second plurality of decode bits to identify the third path and identify the fourth path using a second 4:1 multiplexer.

In combination with any of the above examples, the first 4:1 multiplexer and the second 4:1 multiplexer may operate in parallel.

Alone or in combination with any of the above examples, examples of the present disclosure may include an apparatus. The apparatus may include a transmitter interface communicatively coupled to a transmitter. The apparatus may also include a memory interface. The apparatus may further include a control circuit communicatively coupled to the transmitter interface and the memory interface. The control circuit may be configured to receive, via the transmitter interface, a first PAM symbol group from the transmitter at a first time. The control circuit may also be configured to identify a first path and a second path. The first path and the second path may correspond to a state of the transmitter at the first time and may contain at least two symbols. The control circuit may additionally be configured to store, via the memory interface, a final symbol of the first path and a final symbol of the second path. The control circuit may be configured to receive, via the transmitter interface, a second PAM symbol group from the transmitter at a second time. The control circuit may also be configured to identify, based on the final symbol of the first path, a third path corresponding to a state of the transmitter at a second time. The control circuit may further be configured to identify, based on the final symbol of the second path, a fourth path corresponding to the state of the transmitter at the second time.

In combination with any of the above examples, identifying the third path and identifying the fourth path may include calculating a plurality of scores for a plurality of potential paths corresponding to the state of the transmitter at the second time and selecting the third path and the fourth path from the plurality of potential paths, the third path and the fourth path having lower scores than other of the plurality of potential paths.

In combination with any of the above examples, a final symbol of the third path may be different from a final symbol of the fourth path.

In combination with any of the above examples, a score for the first path may include an effect of the final symbol of the first path on a first symbol of the third path and a score for the second path includes an effect of the final symbol of the second path on a first symbol of the fourth path.

In combination with any of the above examples, the first PAM symbol group may include a first plurality of pre-bits, a first plurality of decode bits, and a first plurality of post-bits. The second PAM symbol group may include a second plurality of pre-bits, a second plurality of decode bits, and a second plurality of post-bits.

In combination with any of the above examples, the control circuit may include an 8:2 multiplexer, a first 4:1 multiplexer, and a second 4:1 multiplexer. Identifying the first path and identifying the second path may include processing the first plurality of pre-bits using the 8:2 multiplexer and processing the first plurality of decode bits to identify the first path and identify the second path using the first 4:1 multiplexer. Identifying the third path and identifying the fourth path may include processing the second plurality of pre-bits of the using the 8:2 multiplexer and processing the second plurality of decode bits to identify the third path and identify the fourth path using the second 4:1 multiplexer.

In combination with any of the above examples, the first 4:1 multiplexer and the second 4:1 multiplexer may operate in parallel.

Alone or in combination with any of the above examples, examples of the present disclosure may include a system. The system may include a receiver communicatively coupled to a transmitter via a communication channel. The system may also include a memory. The system may further include a control circuit communicatively coupled to the receiver and the memory. The control circuit may be configured to receive, via the receiver, a first PAM symbol group from the transmitter at a first time. The control circuit may also be configured to identify a first path and a second path. The first path and the second path may correspond to a state of the transmitter at the first time and each contain at least two symbols. The control circuit may additionally be configured to store, in the memory, a final symbol of the first path and a final symbol of the second path. The control circuit may be configured to receive, via the receiver, a second PAM symbol group from the transmitter at a second time. The control circuit may also be configured to identify, based on the final symbol of the first path, a third path corresponding to a state of the transmitter at the second time. The control circuit may further be configured to identify, based on the final symbol of the second path, a fourth path corresponding to the state of the transmitter at the second time.

In combination with any of the above examples, identifying the third path and identifying the fourth path may include calculating a plurality of scores for a plurality of potential paths corresponding to the second state of the transmitter and selecting the third path and the fourth path from the plurality of potential paths, the third path and the fourth path having lower scores than other of the plurality of potential paths.

In combination with any of the above examples, a final symbol of the third path may be different from a final symbol of the fourth path.

In combination with any of the above examples, a score for the first path may include an effect of the final symbol of the first path on a first symbol of the third path and a score for the second path may include an effect of the final symbol of the second path on a first symbol of the fourth path.

In combination with any of the above examples, the first PAM symbol group may include a first plurality of pre-bits, a first plurality of decode bits, and a first plurality of post-bits. The second PAM symbol group may include a second plurality of pre-bits, a second plurality of decode bits, and a second plurality of post-bits.

In combination with any of the above examples, the control circuit may include an 8:2 multiplexer, a first 4:1 multiplexer, and a second 4:1 multiplexer. Identifying the first path and identifying the second path may include processing the first plurality of pre-bits using the 8:2 multiplexer and processing the first plurality of decode bits to identify the first path and identify the second path using the first 4:1 multiplexer. Identifying the third path and identifying the fourth path may include processing the second plurality of pre-bits of the using the 8:2 multiplexer and processing the second plurality of decode bits to identify the third path and identify the fourth path using the second 4:1 multiplexer.

### BRIEF DESCRIPTION OF THE DRAWINGS

The figures illustrate examples of systems and methods for an improved method of decoding a pulse amplitude modulation symbol group employing a convolutional coding trellis.

FIG. 1 illustrates a block diagram of a system used to decode a PAM symbol group, according to examples of the present disclosure;

FIG. 2 illustrates the encoding of a PAM symbol group using convolutional coding, according to examples of the present disclosure;

FIG. 3 illustrates a block diagram of the use of a control circuit to decode a received PAM symbol group, according to examples of the present disclosure;

FIG. 4 illustrates a system for using multiple engines to decode multiple bit sequences in parallel, according to aspects of the present disclosure;

FIG. 5 illustrates a block diagram illustrating a runup engine using extended symbol SerDes in a decoding scheme for decoding a PAM symbol group, according to examples of the present disclosure;

FIG. 6 illustrates a method for decoding a PAM symbol group, according to examples of the present disclosure; and

FIG. 7 illustrates a more detailed method for decoding a PAM symbol group, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the disclosure, an improved method of decoding a pulse amplitude modulation symbol group employing a convolutional coding trellis is provided. The disclosed decoding method may provide improved performance for lower symbol error rate (SER) and better operating margin for the receiver. The disclosed decoding method may be used in peripheral component interconnect express (PCIe) communications (e.g., Gen7 PCIe at 128 Gigabits per second) and implementations of serializer-deserializer (SerDes).

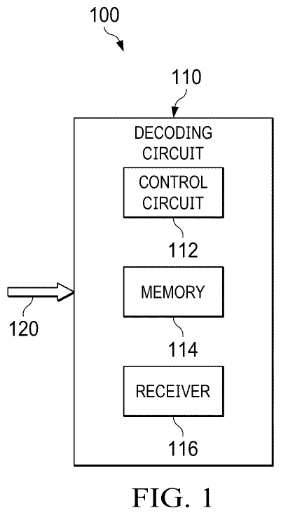

FIG. 1 illustrates a block diagram of a system used to decode a PAM symbol group, according to examples of the present disclosure. System 100 may include decoding circuit 110. Decoding circuit 110 may be communicatively coupled to a transmitter via communication channel 120. Communication channel 120 may be any suitable communication channel used for SerDes communication. For example, communication channel 120 may be a communication link found in high-speed communication systems such as data centers, networking equipment, and high-speed interfaces such as Peripheral Component Interconnect Express (PCIe) and Universal Serial Bus (USB).

Decoding circuit 110 may include control circuit 112, memory 114, and receiver 116. Control circuit 112 may be analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Control circuit 112 may be implemented by instructions for execution by a processor through, for example, a function, application programming interface (API) call, script, program, compiled code, interpreted code, binary, executable, executable file, firmware, object file, container, assembly code, or object. For example, control circuit 112 may be implemented by instructions stored in a non-transitory medium such as a memory that, when loaded and executed by a processor such as a central processing unit (CPU) (or any other suitable process), cause the functionality of control circuit 112 described herein.

Memory 114 may be any suitable type of memory, such as, but not limited to, read-only memory (ROM), random access memory (e.g., RAM, SRAM, DRAM), electrically erasable programmable read-only memory (EEPROM), a Personal Computer Memory Card International Association (PCMCIA) card, flash memory, magnetic storage, opto-magnetic storage, hardware registers, and/or any suitable selection or array of volatile or non-volatile memory.

Receiver 116 may be communicatively coupled to communication channel 120 and receive the bit sequence from a transmitter (not expressly shown). Control circuit 112 may analyze a received bit sequence and determine an input bit sequence that best (most likely) explains the received bit sequence. Stated another way, control circuit 112 may determine an input bit sequence (e.g., an input bit sequence fed to control circuit 112) that most likely produced the received bit sequence.

The input bit sequence may be encoded by a convolutional coder at the transmitter. A convolutional coder is a finite state machine (FSM) with a limited amount of state (e.g., limited number of states). A convolutional coder produces output bits that are various functions of input bits and the previous state. After the output bits are produced, the FSM transitions to a new state based on the input bits and the previous state of the convolutional coder.

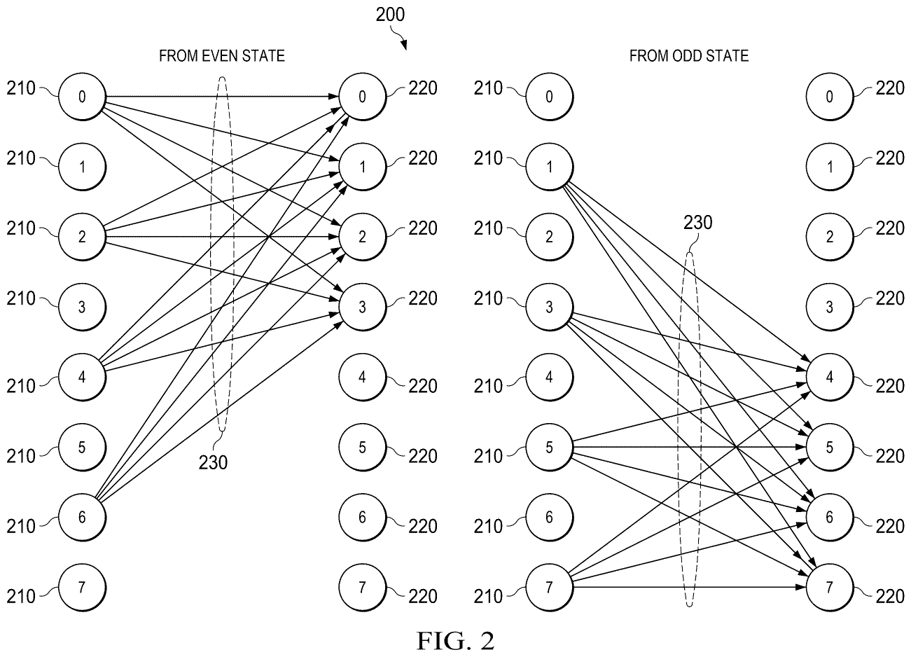

A trellis is a graphical representation of the FSM of the convolutional coder that illustrates the state transitions of the convolutional coder over time. FIG. 2 illustrates the encoding of a PAM symbol group using convolutional coding, according to examples of the present disclosure. A PAM symbol is a unit of transmitted information that represents one or more bits. By way of example, PAM5 provides 2 bits per symbol, PAM8 provides 6 bits per symbol, and PAM12 provides 7 bits per symbol. A PAM symbol group includes two or more PAM symbols.

The trellis includes a first set of nodes (depicted as circles 210 in FIG. 2) that represent possible states at a current time step (t), a second set of nodes (depicted as circles 220 in FIG. 2) that represent possible states at a next time step (t+1), and arcs (depicted as arrows 230 in FIG. 2) that connect nodes at the first current time step (t) to nodes at the second time step (t+1). Each node represents a specific state (e.g., identified by a number). Each arc represents a valid transition from one state to another state.

A convolutional coder may be used by a transmitter to produce encoded output bits that are a function of a current input bit and one or more previous input bits that set the coder's current state. This effectively spreads the information of an input bit (the current input bit) over several output bits, which increases redundancy and the ability of a receiver to detect and correct errors that may occur during transmission. The redundancy introduced by convolutional encoding allows a transmitted signal to be more resilient to the impairments of the channel, such as noise, insertion loss, and interference. The encoded output bits may be modulated onto a carrier using a modulation scheme, e.g., encoded output bits are mapped to physical symbols that are transmitted on communication channel 120 (the transmitted symbols). For example, the transmitter may use pulse amplitude modulation (PAM) to encode data by varying amplitude of electrical pulses using multiple distinct signal levels. As a specific example, the transmitter may use PAM5 to encode data by varying the amplitude of a signal across five voltage levels. Each symbol is represented by one of five voltage levels (e.g., −2, −1, 0, +1, +2). The output of the transmitter may be a set of four PAM5 symbols (e.g., S0, S1, S2, and S3). S0 may be the first symbol to be transmitted and S3 may be the last symbol transmitted. Each PAM5 symbol may be one of five settings (e.g.,−2, −1, 0, 1, or 2). In some examples, the transmitter may output a symbol group including more or fewer PAM symbols in the symbol group. The symbol group may include at least one additional bit beyond the number of bits of the data transmitted. For example, a symbol group using PAM5 may include four symbols and a symbol group using PAM8 may include two symbols.

Referring to the trellis representation shown in FIG. 2, control circuit 112 may consider the finite number of possible states, and the most likely sequence that led to that state, using an algorithm such as the Viterbi algorithm and lookup tables in control circuit 112 that contain data about the previous state and new state. In the example shown in FIG. 2, control circuit 112 would have a 4:1 path selection for each state. While eight states are shown in FIG. 2, more or fewer states may be used based on the configuration of the trellis used to encode the symbols. For example, some convolutional coding schemes may use 16 states.

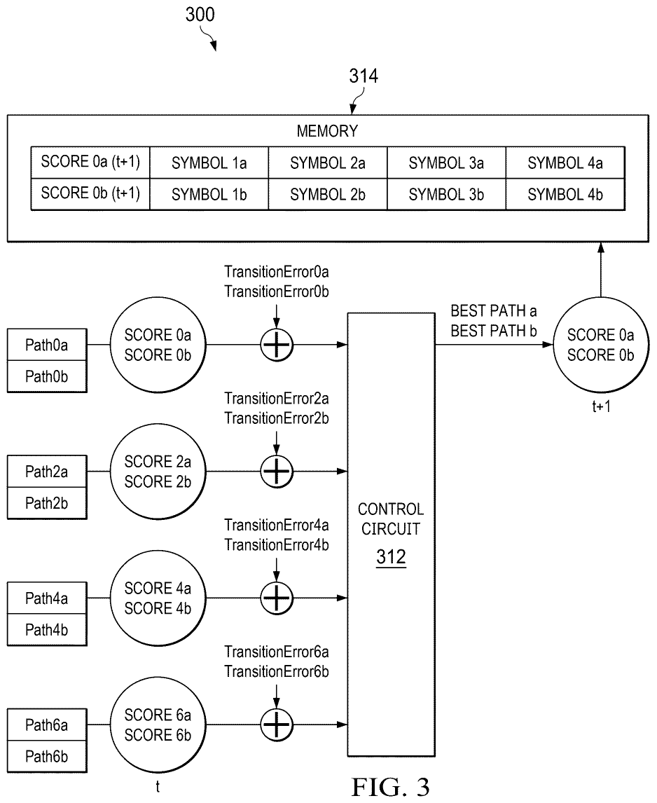

To decode the received sequence, control circuit 112 may use extended symbol SerDes decoding. Extended symbol SerDes decoding may add two additional parameters to the trellis decoding process. Specifically, the final symbol from the previous state may be retained to determine the first symbol of the received sequence, as explained in further detail with respect to FIG. 3 below.

FIG. 3 illustrates a block diagram of the use of a control circuit to decode a received PAM symbol group, according to examples of the present disclosure. System 300 may include control circuit 312 and memory 314, which may be similar to control circuit 112 and memory 114, respectively, shown in FIG. 1. FIG. 3 illustrates the decoding of a PAM symbol group for a given state. However, control circuit 312 may perform the process described with respect to FIG. 3 for all states in the trellis (e.g., states 0 through 7 shown in FIG. 2). Therefore, at any given time, control circuit 312 and memory 314 maintain information for the states of the trellis and the two best paths (e.g., history of PAM symbols) used to arrive at the given state.

Control circuit 312 may be an 8:2 multiplexer. The input to control circuit 312 may be a PAM symbol received from a transmitter. The received PAM symbol may arrive at control circuit 312 via one of eight paths, labeled Path 0a, Path 0b, Path 2a, Path 2b, Path 4a, Path 4b, Path 6a, and Path 6b in FIG. 3. Control circuit 312 may determine the most likely path by which the PAM symbol, arrived as explained below. For simplicity, FIG. 3 illustrates the paths from even states at a first time, t, to state 0 at a second time, t+1 (shown in the left trellis of FIG. 2). However, control circuit 312 may also analyze paths from odd states (shown in the right trellis of FIG. 2).

Control circuit 312 may assign a state score to the eight paths. In FIG. 3, the state score is identified as Score 0a, Score 0b, Score 2a, Score 2b, Score 4a, Score 4b, Score 6a, and Score 6b, corresponding to Path 0a, Path 0b, Path 2a, Path 2b, Path 4a, Path 4b, Path 6a, and Path 6b, respectively. The state score may represent the accumulated distance of that state for a state path at a first time step. (t). A low state score may mean a good fit between the path and the received bit sequence. A high state score may mean a poor fit between the path and the received bit sequence. The pair of scores for a given state (e.g., Score 0a and Score 0b) may represent the best and second best paths for the given state. Similarly, the pair of paths for a given state (e.g., Path 0a and Path 0b) may represent the best and second best paths for the given state with the constraint that the final (e.g., most recent) symbols of the pair of paths are different. For example, if the best and second best paths have the same final symbol, the pair of paths may be the best path and the next best path with a different final symbol.

For a given path, control circuit 312 performs an Add-Compare-Select (ACS) operation to determine the best fitting path. In the “add” operation, control circuit 312 determines the cumulative score for the given path by adding the current transition error (e.g., Transition Error 0a, Transition Error 0b, Transition Error 2a, Transition Error 2b, Transition Error 4a, Transition Error 4b, Transition Error 6a, and Transition Error 6b, corresponding to Score 0a, Score 0b, Score 2a, Score 2b, Score 4a, Score 4b, Score 6a, and Score 6b, respectively) to the state's score at a previous time step (t−1). The current transition error is based on a decision feedback equalization (DFE) technique. DFE is a signal processing technique used at the receiver end of a communication link (e.g., by control circuit 312), to account for intersymbol interference (ISI) and other distortions in high-speed communication links. DFE operates based on feedback. Decisions made by control circuit 312 for previous symbols (e.g., at time t−1) are used to reduce (e.g., cancel out, without limitation) ISI for the current symbol (e.g., at time t). For example, control circuit 312 may sample a received signal and make a preliminary decision about a current transmitted symbol (a “symbol decision”) based on the sampled signal. The preliminary decision may be affected by ISI from previously transmitted symbols. Control circuit 312 may use the decisions from previously decoded symbols to estimate the ISI contributions of the previously decoded symbols to the received signal. Control circuit 312 may subtract the estimated contributions from the current sample to account for ISI. Control circuit 312 may then make a more accurate decision about the current transmitted symbol. Control circuit 312 may continue this process, with feedback information improving the accuracy of subsequent symbol decisions, thereby enhancing overall data recovery. DFE is used in PAM5 receivers to recover transmitted data from the received signal.

A symbol received at time n may be equal to a transmitted symbol at time n plus the DFE tap times the transmitted symbol at time n−1 (e.g., R(n)=T(n)+T(n−1)*DFE tap). For example, the DFE tap may be 0.75 and transmitted symbol group at time n may be formed of four PAM5 symbols {−2, 0, −1, 1}. The transmitted symbol at time n−1 may be −1. Therefore, the received symbols may be calculated using the formula to be {−2.75, −1.5, −1, 0.25}. When control circuit 312 decodes the symbol, control circuit 312 calculates how well each possible symbol group matches the received information, accounting for ISI. Returning to the example, assume that the received symbol group is from state 0 to state 0. Control circuit 312 may calculate the “distance” to each possible symbol group that could lead to the next state. A lower distance means a better fit. Control circuit 312 may identify that a symbol group of {−2.75, −1.5, −1, 0.25} has a “0” distance. Control circuit 312 may also calculate the distance for other arcs. For example, an arc from state 2 to state 0 may have a transmitted symbol group at time n of {1, 1, 2, 0}. The transmitted symbol at time n−1 may be −1. Control circuit 312 may use the formula to calculate that the received symbols are {0.25, 1.75, 2.75, 1.5}. However, the actual symbols received are {−2.75, −1.5, −1, 0.25}. Control circuit 312 may calculate a branch metric score for the transition from state 2 to state 0 as the absolute values of the difference of the calculated received symbols and the actual received symbols (e.g., abs(0.25−−2.75)+abs(1.75−−1.5)+abs(2.75−−1)+abs(1.5−0.25))=11.25). Control circuit 312 may calculate the transition error scores for the possible transitions. The actual transition matching the transmission sent will have an error of zero, while the other transitions will have worse (e.g., higher) transition error scores. Therefore, control circuit 312, using 8:2 filtering at each state, may select the two paths that best fit the symbols received based on the sum of the path score from a previous state plus the transition error score indicating how well the received symbols match the pattern that is used to transition to the next state.

In the “compare” operation, control circuit 312 compares the scores of the possible paths. In the “select” operation, control circuit 312 selects the paths with the lowest cumulative score. To improve the accuracy of the decoding, control circuit 312 may select two possible paths with the lowest cumulative scores (labeled “Best Path a” and “Best Path b” in FIG. 3). The final symbol of the two selected paths are different. Control circuit 312 may save the final symbol from the Best Path a and Best Path b (e.g., save in memory 314). Because the final symbol of the two possible paths are different, Symbol 4a and Symbol 4b are different.

Control circuit 312 may receive the next PAM symbol at time step t+1. When calculating the transition error at the next time step (t+1), control circuit 312 may use Symbol 4a and Symbol 4b. Specifically, Transition Error 0a, Transition Error 2a, Transition Error 4a, and Transition Error 6b maybe calculated based on Symbol 4a and Transition Error 0b, Transition Error 2b, Transition Error 4b, and Transition Error 6b maybe calculated based on Symbol 4b. Control circuit 312 may then use an ACS operation to identify the two selected paths for the state at time t+2.

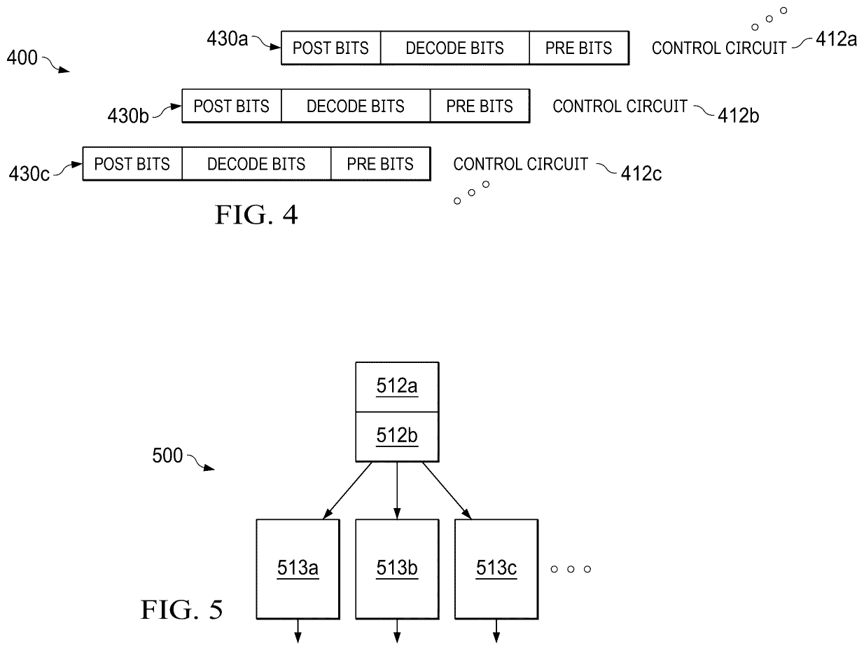

FIG. 4 illustrates a system for using multiple engines to decode multiple bit sequences in parallel, according to aspects of the present disclosure. A received bit sequence 430a, 430b, and 430c may include pre-bits, decode bits, and post-bits. The pre-bits (or runup bits) may be used to initialize the trellis, as explained in more detail below. The decode bits may be the symbol group to decode. The post-bits (or rundown bits) may close the trellis. Extended symbol SerDes decoding may also be used to reduce the runup time within the windowed maximum likelihood sequence estimation (MLSE) decoder. MLSE is a signal processing technique that considers multiple symbol sequences and selects the sequence it determines has the highest likelihood of being the transmitted sequence. MLSE evaluates these sequences by considering the received signal, channel characteristics, and statistical properties of the transmission. As data rates increase (e.g., 112 Gbps, 128 Gbps, 224 Gbps), MLSE is used to reduce symbol error rate (SER). MLSE uses a trellis structure, such as the trellis structure shown in FIG. 2, to decode the received symbol.

Initializing a trellis of an MLSE engine is the process of setting its state to represent the memory of a communication channel. When a control circuit (e.g., control circuit 112 or control circuit 312 shown in FIGS. 1 and 3, respectively) begins decoding in an uninitialized state (e.g., a cold start), the control circuit may lack knowledge of the past symbols that affected the current state of the communication channel, which the trellis represents. As a result, the control circuit might select a transmitted sequence that is different from the sequence the control circuit would choose with full or partial knowledge of the channel's memory.

To reduce undesirable effects of a cold start, pre-bit symbols may be provided to the control circuit before an actual received sequence of symbols (the “decode bits”). Pre-bits are a sequence of symbols provided before the decode bits. Once the trellis is initialized using the pre-bits, the control circuit may begin decoding a received sequence with a state more representative of actual channel conditions.

For high speed communication channels, the control circuit may not be able to process the symbols arriving at the control circuit in a reasonable period of time. For example, at 128 gigabits per second (Gbit/s), 64 PAM5 symbols may be received per nanosecond. The control circuit may be able to process approximately two symbol groups per nanosecond (e.g., eight PAM5 symbols per nanosecond). Therefore, a decoding circuit (e.g., decoding circuit 110 shown in FIG. 1), may include multiple control circuits 412a, 412b, and 412c operating in parallel. Control circuits 412a, 412b, and 412c may run in parallel to decode received bit sequences in a windowed manner. For example, control circuit 412a may process bit sequence 430a, control circuit 412b may process bit sequence 430b, and control circuit 412c may process bit sequence 430c. While FIG. 4 illustrates three control circuits 412a, 412b, and 412c, system 400 may include additional control circuits 412 based on the rate at which data is received at the decoding circuit. For example, where the decoding circuit receives 64 symbols per nanosecond and a control circuit can decode eight symbols per nanosecond, the decoding circuit may include eight control circuits 412. The number of engines may be determined based on the following formula:

$$Number of Engines = \frac{\begin{matrix}Number of Pre - Bits + \\ Number of Decode Bits + Number of Post - Bits\end{matrix}}{Number of Decode Bits}$$

Control circuit 412b may not begin processing the decode bits in bit sequence 430b until control circuit 412a completes processing the decode bits in bit sequence 430a. Therefore, the final symbols of the decode bits in bit sequence 430a may be used to decode the decode bits in bit sequence 430b, as explained with respect to FIG. 3. However, control circuit 412b may process the pre-bits in bit sequence 430b while control circuit 412a decodes the decode bits in bit sequence 430a.

FIG. 5 illustrates a block diagram illustrating a runup engine using extended symbol SerDes in a decoding scheme for decoding a PAM symbol group, according to examples of the present disclosure. System 500 may include multiple types of control circuits 512 and 513. For example, control circuits 512a and 512b may be similar to control circuit 312 shown in FIG. 3. Specifically, control circuits 512a and 512b may be 8:2 multiplexers. Control circuits 513a, 513b, and 513c may also be similar to control circuit 312 shown in FIG. 3 and may be 8:2 multiplexers. However, in some examples, control circuits 513a, 513b, 513c may be 4:1 multiplexers. In these examples, control circuits 513a, 513b, 513c may decode bit sequences by saving a final bit of a previous transmission. Specifically, referring to FIG. 3, control circuits 513a, 513b, 513c may consider four possible paths (e.g., Path 0a, Path 2a, Path 4a, and Path 6a) and may select one “best” path.

Control circuits 512a and 512b may process the pre-bits of a received bit sequence. By using 8:2 multiplexer control circuits 512a and 512b to process the pre-bits, the pre-bits may be processed more quickly and with greater accuracy, reducing the number of the pre-bits used to initialize the trellis. Reducing the number of pre-bits may also reduce latency and overhead. Once control circuits 512a and 512b process some or all the pre-bits of a bit sequence, control circuits 512a and 512b may pass the bit sequence to one of control circuits 513a, 513b, or 513c to complete processing of the pre-bits, decode bits, and post-bits. Therefore, control circuits 513a, 513b, or 513c may be constituent decoders to control circuits 512a and 512b. Control circuits 512a and 512b may operate in parallel to efficiently process bit sequences.

While control circuits 513a, 513b, and 513c are described as being 4:1 multiplexers, control circuits 513a, 513b, and 513c may also be 8:2 multiplexers to improve the performance of system 500. Where control circuits 512a, 512b, 513a, 513b, and 513c are 8:2 multiplexers, system 500 may be larger. Therefore, where control circuits 512a and 512b are 8:2 multiplexers and control circuits 513a, 513b, and 513c are 4:1 multiplexers, the size of system 500 may not be significantly increased while providing improved performance.

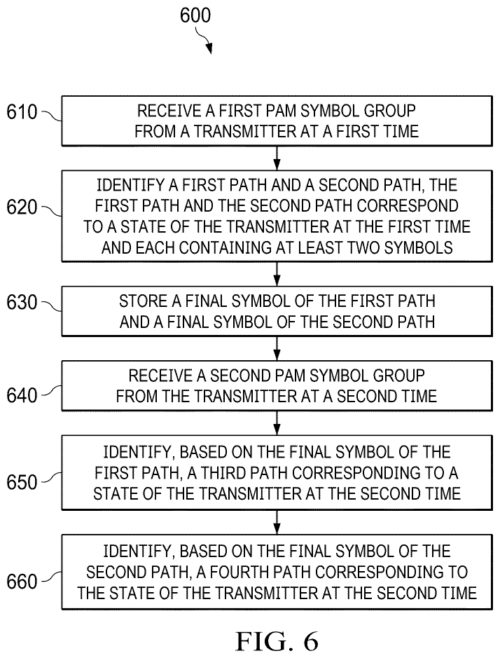

FIG. 6 illustrates a method for decoding a PAM symbol group, according to examples of the present disclosure. Method 600 may be implemented by a decoding circuit, such as decoding circuit 110 shown in FIG. 1, including a control circuit, memory, and a receiver. Although examples have been described above, other variations and examples may be made from this disclosure without departing from the spirit and scope of these disclosed examples. FIG. 6 illustrates the decoding of a PAM symbol group for a given state. However, the control circuit may perform method 600 for all states in the trellis (e.g., states 0 through 7 shown in FIG. 2). Therefore, at any given time, the control circuit and a memory maintain information for the states of the trellis and the two best paths (e.g., history of PAM symbols) used to arrive at the given state.

Method 600 may begin at block 610, where a decoding circuit may receive a first PAM symbol group from a transmitter at a first time (t). The decoding circuit may receive the first PAM symbol group via a transmitter interface communicatively coupled to a receiver. The receiver may receive the first PAM symbol group from the transmitter and communicate the first PAM symbol group to the control circuit of the decoding circuit via the transmitter interface. As an example, where method 600 uses PAM5 modulation, the first PAM symbol group may be a sequence of four PAM5 symbols.

At block 620, the control circuit may identify a first path and a second path. The first path and the second path may correspond to a state of the transmitter at the first time. The first path and the second path may contain four symbols. The final symbol of the first path may be different from the final symbol of the second path. The first path and the second path may be the two mostly likely paths by which the first PAM symbol group arrived from the transmitter. The control circuit may identify the first path and the second path using an Add-Compare-Select operation as described in more detail with respect to FIG. 3.

At block 630, the control circuit may store a final symbol of the first path and a final symbol of the second path. The final symbols may be stored in a memory of the decoding circuit (e.g., memory 114 shown in FIG. 1). The control circuit may be communicatively coupled to the memory via a memory interface.

At block 640, the decoding circuit may receive a second PAM symbol group from the transmitter at a second time (t+1). The decoding circuit may receive the second PAM symbol group via the transmitter interface communicatively coupled to the receiver. The receiver may receive the second PAM symbol group from the transmitter and communicate the second PAM symbol group to the control circuit of the decoding circuit via the transmitter interface. As an example, where method 600 uses PAM5 modulation, the second PAM symbol group may be a sequence of four PAM5 symbols.

At block 650, the decoding circuit may identify, based on the final symbol of the first path (stored at block 630), a third path corresponding to a state of the transmitter at the second time. The third path may contain four symbols. The third path may be a likely path by which the second PAM symbol group arrived from the state transmitted by the transmitter. The control circuit may identify the third path using an Add-Compare-Select operation as described in more detail with respect to FIG. 3.

At block 660, the decoding circuit may identify, based on the final symbol of the second path (stored at block 630), a fourth path corresponding to the state of the transmitter at the second time. The fourth path may contain four symbols. The fourth path may be a likely path by which the second PAM symbol group arrived from the state transmitted by the transmitter. The control circuit may identify the fourth path using an Add-Compare-Select operation as described in more detail with respect to FIG. 3.

Method 600 may repeat steps 640 through 660 while the control circuit continues to receive symbols. Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

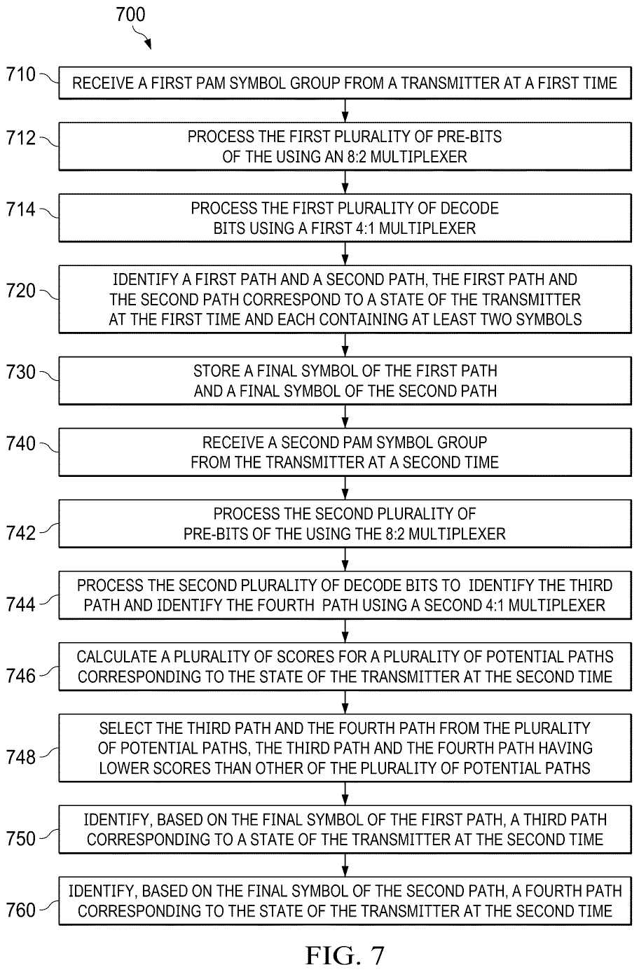

FIG. 7 illustrates a more detailed method for decoding a PAM symbol group, according to examples of the present disclosure. Method 700 may be implemented by a decoding circuit, such as decoding circuit 110 shown in FIG. 1, including a control circuit, memory, and a receiver. Although examples have been described above, other variations and examples may be made from this disclosure without departing from the spirit and scope of these disclosed examples. FIG. 7 illustrates the decoding of a PAM symbol group for a given state. However, the control circuit may perform method 700 for all states in the trellis (e.g., states 0 through 7 shown in FIG. 2). Therefore, at any given time, the control circuit and a memory maintain information for the states of the trellis and the two best paths (e.g., history of PAM symbols) used to arrive at the given state.

Method 700 may begin at block 710, where a decoding circuit may receive a first PAM symbol group from a transmitter at a first time (t). The decoding circuit may receive the first PAM symbol group via a transmitter interface communicatively coupled to a receiver. The receiver may receive the first PAM symbol group from the transmitter and communicate the first PAM symbol group to the control circuit of the decoding circuit via the transmitter interface. The first PAM symbol group may be a sequence of four PAM5 symbols. The first PAM symbol group may include a first plurality of pre-bits, a first plurality of decode bits, and a first plurality of post-bits.

At block 712, the control circuit may process the first plurality of pre-bits using an 8:2 multiplexer. The control circuit may process the pre-bits of a received bit sequence. By using an 8:2 multiplexer, the pre-bits may be processed more quickly and with greater accuracy, reducing the number of the pre-bits used to initialize the trellis. Reducing the number of pre-bits may also reduce latency and overhead.

At block 714, the control circuit may process the first plurality of decode bits using a first 4:1 multiplexer. Once the first plurality of decode bits are processed, method 700 may proceed to block 720 to identify the first path and the second path. Once the control circuit processes some or all the pre-bits of a bit sequence, the control circuit may pass the bit sequence to the first 4:1 multiplexer to complete processing of the pre-bits, decode bits, and post-bits. Therefore, the first 4:1 multiplexer may be a constituent decoder to the 8:2 multiplexer.

At block 720, the control circuit may identify a first path and a second path. The first path and the second path may correspond to a state of the transmitter at the first time. The first path and the second path may contain four symbols. The final symbol of the first path may be different from the final symbol of the second path. The first path and the second path may be the two mostly likely paths by which the first PAM symbol group arrived from the transmitter. The control circuit may identify the first path and the second path using an Add-Compare-Select operation as described in more detail with respect to FIG. 3.

At block 730, the control circuit may store a final symbol of the first path and a final symbol of the second path. The final symbols may be stored in a memory of the decoding circuit (e.g., memory 114 shown in FIG. 1). The control circuit may be communicatively coupled to the memory via a memory interface.

At block 740, the decoding circuit may receive a second PAM symbol group from the transmitter at a second time (t+1). The decoding circuit may receive the second PAM symbol group via the transmitter interface communicatively coupled to the receiver. The receiver may receive the second PAM symbol group from the transmitter and communicate the second PAM symbol group to the control circuit of the decoding circuit via the transmitter interface. The second PAM symbol group may be a sequence of four PAM5 symbols. The second PAM symbol group may include a second plurality of pre-bits, a second plurality of decode bits, and a second plurality of post-bits.

At block 742, the control circuit may process the second plurality of pre-bits using an 8:2 multiplexer. The control circuit may process the pre-bits of a received bit sequence. By using an 8:2 multiplexer, the pre-bits may be processed more quickly and with greater accuracy, reducing the number of the pre-bits used to initialize the trellis. Reducing the number of pre-bits may also reduce latency and overhead.

At block 744, the control circuit may process the second plurality of decode bits using a second 4:1 multiplexer. Once the second plurality of decode bits are processed, method 700 may proceed to block 746 to begin the process of identifying the third path and the fourth path. Once the control circuit processes some or all the pre-bits of a bit sequence, the control circuit may pass the bit sequence to the second 4:1 multiplexer to complete processing of the pre-bits, decode bits, and post-bits. Therefore, the second 4:1 multiplexer may be a constituent decoder to the 8:2 multiplexer. The first 4:1 multiplexer and the second 4:1 multiplexer may operate in parallel to efficiently process bit sequences.

At block 746, the control circuit may calculate a plurality of scores for a plurality of potential paths corresponding to the second state of the transmitter. The score may be a cumulative score based on a state score and a transition error for a given path of the plurality of potential paths. The state score may represent the accumulated distance of that state for a state path. The transition error is based on a decision feedback equalization (DFE) technique as described in more detail with respect to FIG. 3.

At block 748, the control circuit may select the third path and the fourth path from the plurality of potential paths. A low score may mean a good fit between the path and the received PAM symbol. A state score may mean a poor fit between the path and the received PAM symbol. The third path and the fourth pay may have lower scores than other of the plurality of potential paths. The selection of the third path and the fourth path may take into consideration that the final symbol of the third path is different from the final symbol of the fourth path.

At block 750, the decoding circuit may identify, based on the final symbol of the first path (stored at block 730), a third path corresponding to a state of the transmitter at the second time. The third path may contain four symbols. The third path may be a likely path by which the second PAM symbol group arrived from transmitter. The control circuit may identify the third path using an Add-Compare-Select operation as described in more detail with respect to FIG. 3.

At block 760, the decoding circuit may identify, based on the final symbol of the second path (stored at block 730), a fourth path corresponding to the state of the transmitter at the second time. The fourth path may contain four symbols. The fourth path may be a likely path by which the second PAM symbol group arrived from the transmitter. The control circuit may identify the fourth path using an Add-Compare-Select operation as described in more detail with respect to FIG. 3.

Method 700 may repeat steps 740 through 760 while the control circuit continues to receive symbols. Although FIG. 7 discloses a particular number of operations related to method 700, method 700 may be executed with greater or fewer operations than those depicted in FIG. 7. In addition, although FIG. 7 discloses a certain order of operations to be taken with respect to method 700, the operations comprising method 700 may be completed in any suitable order.

While PAM5 modulation is used to illustrate the systems and methods described in this disclosure, the disclosed system and methods may be used with other PAM modulation schemes. For example, other PAM modulation schemes using more or fewer symbols in a symbol group may be used. Additionally, PAM modulation schemes using more or fewer layers than PAM5 may also be used. Further, while PAM5 includes eight states, other convolutional coding schemes may use more or fewer states. For example, a convolutional coding scheme may use sixteen states.

Although examples have been described above, other variations and examples may be made from this disclosure without departing from the spirit and scope of these disclosed examples.

1. A method, comprising:
receiving a first PAM symbol group from a transmitter at a first time;
identifying a first path and a second path, the first path and the second path correspond to a state of the transmitter at the first time and each containing at least two symbols;
storing a final symbol of the first path and a final symbol of the second path;
receiving a second PAM symbol group from the transmitter at a second time;
identifying, based on the final symbol of the first path, a third path corresponding to a state of the transmitter at the second time; and
identifying, based on the final symbol of the second path, a fourth path corresponding to the state of the transmitter at the second time.

2. The method of claim 1, wherein identifying the third path and identifying the fourth path includes:
calculating a plurality of scores for a plurality of potential paths corresponding to the state of the transmitter at the second time; and
selecting the third path and the fourth path from the plurality of potential paths, the third path and the fourth path having lower scores than other of the plurality of potential paths.

3. The method of claim 2, wherein a final symbol of the third path is different from a final symbol of the fourth path.

4. The method of claim 2, wherein a score for the first path includes an effect of the final symbol of the first path on a first symbol of the third path and a score for the second path includes an effect of the final symbol of the second path on a first symbol of the fourth path.

5. The method of claim 1, wherein:
the first PAM symbol group includes a first plurality of pre-bits, a first plurality of decode bits, and a first plurality of post-bits; and
the second PAM symbol group includes a second plurality of pre-bits, a second plurality of decode bits, and a second plurality of post-bits.

6. The method of claim 5, wherein:
identifying the first path and identifying the second path includes:
processing the first plurality of pre-bits of the using an 8:2 multiplexer; and
processing the first plurality of decode bits to identify the first path and identify the second path using a first 4:1 multiplexer; and
identifying the third path and identifying the fourth path includes:
processing the second plurality of pre-bits using the 8:2 multiplexer; and
processing the second plurality of decode bits to identify the third path and identify the fourth path using a second 4:1 multiplexer.

7. The method of claim 6, wherein the first 4:1 multiplexer and the second 4:1 multiplexer operate in parallel.

8. An apparatus, comprising:
a transmitter interface communicatively coupled to a transmitter;
a memory interface; and
a control circuit communicatively coupled to the transmitter interface and the memory interface, the control circuit to:
receive, via the transmitter interface, a first PAM symbol group from the transmitter at a first time;
identify a first path and a second path, the first path and the second path correspond to a state of the transmitter at the first time and each containing at least two symbols;
store, via the memory interface, a final symbol of the first path and a final symbol of the second path;
receive, via the transmitter interface, a second PAM symbol group from the transmitter at a second time;
identify, based on the final symbol of the first path, a third path corresponding to a state of the transmitter at a second time; and
identify, based on the final symbol of the second path, a fourth path corresponding to the state of the transmitter at the second time.

9. The apparatus of claim 8, wherein identifying the third path and identifying the fourth path includes:
calculating a plurality of scores for a plurality of potential paths corresponding to the state of the transmitter at the second time; and
selecting the third path and the fourth path from the plurality of potential paths, the third path and the fourth path having lower scores than other of the plurality of potential paths.

10. The apparatus of claim 9, wherein a final symbol of the third path is different from a final symbol of the fourth path.

11. The apparatus of claim 9, wherein a score for the first path includes an effect of the final symbol of the first path on a first symbol of the third path and a score for the second path includes an effect of the final symbol of the second path on a first symbol of the fourth path.

12. The apparatus of claim 8, wherein:
the first PAM symbol group includes a first plurality of pre-bits, a first plurality of decode bits, and a first plurality of post-bits; and
the second PAM symbol group includes a second plurality of pre-bits, a second plurality of decode bits, and a second plurality of post-bits.

13. The apparatus of claim 12, wherein:
the control circuit includes an 8:2 multiplexer, a first 4:1 multiplexer, and a second 4:1 multiplexer;
identifying the first path and identifying the second path includes:
processing the first plurality of pre-bits using the 8:2 multiplexer; and
processing the first plurality of decode bits to identify the first path and identify the second path using the first 4:1 multiplexer; and
identifying the third path and identifying the fourth path includes:
processing the second plurality of pre-bits of the using the 8:2 multiplexer; and
processing the second plurality of decode bits to identify the third path and identify the fourth path using the second 4:1 multiplexer.

14. The apparatus of claim 13, wherein the first 4:1 multiplexer and the second 4:1 multiplexer operate in parallel.

15. A system, comprising:
a receiver communicatively coupled to a transmitter via a communication channel;
a memory; and
a control circuit communicatively coupled to the receiver and the memory, the control circuit to:
receive, via the receiver, a first PAM symbol group from the transmitter at a first time;
identify a first path and a second path, the first path and the second path correspond to a state of the transmitter at the first time and each containing at least two symbols;
store, in the memory, a final symbol of the first path and a final symbol of the second path;
receive, via the receiver, a second PAM symbol group from the transmitter at a second time;
identify, based on the final symbol of the first path, a third path corresponding to a state of the transmitter at the second time; and
identify, based on the final symbol of the second path, a fourth path corresponding to the state of the transmitter at the second time.

16. The system of claim 15, wherein identifying the third path and identifying the fourth path includes:
calculating a plurality of scores for a plurality of potential paths corresponding to the second state of the transmitter; and
selecting the third path and the fourth path from the plurality of potential paths, the third path and the fourth path having lower scores than other of the plurality of potential paths.

17. The system of claim 16, wherein a final symbol of the third path is different from a final symbol of the fourth path.

18. The system of claim 16, wherein a score for the first path includes an effect of the final symbol of the first path on a first symbol of the third path and a score for the second path includes an effect of the final symbol of the second path on a first symbol of the fourth path.

19. The system of claim 15, wherein:
the first PAM symbol group includes a first plurality of pre-bits, a first plurality of decode bits, and a first plurality of post-bits; and
the second PAM symbol group includes a second plurality of pre-bits, a second plurality of decode bits, and a second plurality of post-bits.

20. The system of claim 19, wherein:
the control circuit includes an 8:2 multiplexer, a first 4:1 multiplexer, and a second 4:1 multiplexer;
identifying the first path and identifying the second path includes:
processing the first plurality of pre-bits using the 8:2 multiplexer; and
processing the first plurality of decode bits to identify the first path and identify the second path using the first 4:1 multiplexer; and
identifying the third path and identifying the fourth path includes:
processing the second plurality of pre-bits of the using the 8:2 multiplexer; and
processing the second plurality of decode bits to identify the third path and identify the fourth path using the second 4:1 multiplexer.
